(19) United States
(12) Patent Application Publication
(10) Pub. No.: US 2018/0179444 A1
(43) Pub. Date: Jun. 28, 2018

(54) LIQUID CRYSTAL COMPOSITION AND A LIQUID CRYSTAL DISPLAY INCLUDING THE SAME

(71) Applicant: SAMSUNG DISPLAY CO., LTD., Yongin-si (KR)

(72) Inventors: Joon Hyung Park, Yongin-si (KR); Kyung Hae Park, Yongin-si (KR); Jong Ho Son, Yongin-si (KR); Won Gap Yoon, Yongin-si (KR); Young Joo Jeon, Yongin-si (KR)

(21) Appl. No.: 15/651,355

(22) Filed: Jul. 17, 2017

(30) Foreign Application Priority Data
Dec. 22, 2016 (KR) 10-2016-0176933

(51) Int. Cl. C09K 19/30; G02F 1/1335; G02F 1/1343; G02F 1/137

(52) U.S. Cl. CPC C09K 19/3098; G02F 1/133514; G02F 2001/13712; G02F 1/137; G02F 2202/36; G02F 1/134309

(57) ABSTRACT

A liquid crystal display includes a first base substrate; a second base substrate facing the first base substrate; an electrode unit disposed on at least one of the first base substrate and the second base substrate; and a liquid crystal layer disposed between the first base substrate and the second base substrate and includes a liquid crystal composition. The liquid crystal composition includes at least one of liquid crystal compounds represented by Formulae 1 to 2.

### CROSS-REFERENCE TO RELATED APPLICATION

This application claims priority under 35 U.S.C. § 119 to Korean Patent Application No. 10-2016-0176933 filed in the Korean Intellectual Property Office on Dec. 22, 2016, the disclosure of which is incorporated by reference herein in its entirety.

### TECHNICAL FIELD

Exemplary embodiments of present invention relate to a liquid crystal composition, and more particularly to a liquid crystal display including the same.

### DISCUSSION OF RELATED ART

A liquid crystal display includes a first substrate, a second substrate, and a liquid crystal layer. The first substrate includes a plurality of pixel electrodes. The second substrate includes a common electrode. The liquid crystal layer is disposed between the first substrate and the second substrate. The liquid crystal display displays an image, for example, by varying light transmittance of the liquid crystal layer according to an electric field formed between each of the pixel electrodes and the common electrode. The liquid crystal display includes a plurality of pixels. Each of the plurality of pixels includes the pixel electrode.

A liquid crystal display may provide greater image information to a user. For example, the liquid crystal display may display a three-dimensional image in addition to a two-dimensional image. Accordingly, a liquid crystal display having a relatively high driving speed and relatively high reliability may be provided.

### SUMMARY

Exemplary embodiments of the present invention provide a liquid crystal display. The liquid crystal display includes a first substrate; a second substrate facing the first substrate; an electrode unit disposed on at least one of the first substrate and the second substrate; and a liquid crystal layer disposed between the first substrate and the second substrate. The liquid crystal layer includes a liquid crystal composition. The liquid crystal composition includes at least one of liquid crystal compounds represented by Formulae 1 to 2.

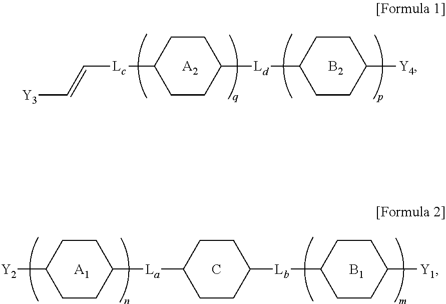

A₁, A₂, B₁ and B₂ are each selected from 1,4-cyclohexylene or 1,4-phenylene. —H of A₁, A₂, B₁ and B₂ are each able to be substituted with —F, —Cl, —OCF₃, —CF₃, —CHF₂, or —CH₂F. C is 1,4-cyclohexenylene having —C═C— bond at a first carbon, a second carbon, or a third carbon. Y₁, Y₂, Y₃ and Y₄ are each selected from —H or C1-C5 alkyl. One or more —CH₂— groups are each able to be substituted with —C≡C—, —CH═CH—, —CF₂O—, —O—, —CO—O—, —O—CO— or —O—CO—O—. n,
m, p and q are each an integer selected from 0 to 2. Lₐ, L_{b}, L_{c}, and L_{d} are each selected from a single bond, —C≡O—, —OCO—, —OCO—, —CF₂O—, —OCF₂—, —CH₂O—, —CO—, —O—, —(CH₂)₂—, or —CH═CH—.

According to an exemplary embodiment of the present invention, an optical path difference (Δnd) of the liquid crystal layer may be about 245 nm to about 310 nm.

According to an exemplary embodiment of the present invention, a refractive anisotropy (Δn) of the liquid crystal layer may be about 0.075 to about 0.1.

According to an exemplary embodiment of the present invention, a ratio γ1/K33 of a rotational viscosity (γ1) of the liquid crystal layer to a bending elastic modulus (K33) may be 4 to 8.

According to an exemplary embodiment of the present invention, the liquid crystal compound of Formula 1 may be present in an amount of more than about 0 wt % to about 10 wt %.

According to an exemplary embodiment of the present invention, the liquid crystal compound of Formula 2 may be present in an amount of more than about 0 wt % to about 5 wt %.

According to an exemplary embodiment of the present invention, the liquid crystal compound of Formula 2 may include at least one of liquid crystal compounds represented by Formula 2-1.

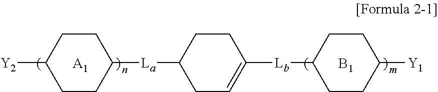

A₁, B₁, n, m, Lₐ, L_{b}, Y₁, and Y₂ may be the same as defined in Formula 2.

According to an exemplary embodiment of the present invention, the liquid crystal composition may have a negative dielectric anisotropy.

According to an exemplary embodiment of the present invention, the liquid crystal layer may be driven in a vertical aligned mode.

According to an exemplary embodiment of the present invention, a liquid crystal display may further include a light source spaced apart from the second substrate, and the first substrate is disposed between the light source and the second substrate.

According to an exemplary embodiment of the present invention, the light source may emit light having a wavelength of about 450 nm to about 495 nm.

According to an exemplary embodiment of the present invention, a liquid crystal display may further include a color filter disposed on the second substrate. The color filter may include a first quantum dot and a second quantum dot. The second quantum dot may be different from the first quantum dot.

According to an exemplary embodiment of the present invention, a liquid crystal composition used in a liquid crystal display includes at least one of liquid crystal compounds represented by Formulae 1 to 2. The liquid crystal composition has a refractive anisotropy (Δn) of about 0.075 to about 0.1 when exposed to light having a predetermined wavelength.

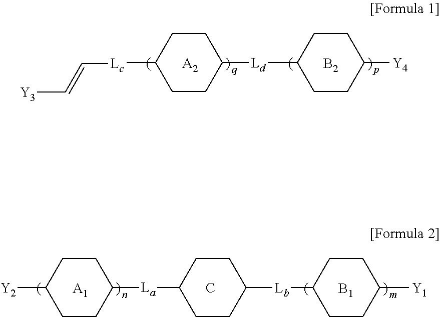

A₁, A₂, B₁ and B₂ are each selected from 1,4-cyclohexylene or 1,4-phenylene. —H of A₁, A₂, B₁ and B₂ are each able to be substituted with —F, —Cl, —OCF₃, —CF₃, —CHF₂, or —CH₂F. C is 1,4-cyclohexenylene having —C═C— bond at a first carbon, a second carbon, or a third carbon. Y₁, Y₂, Y₃ and Y₄ are each selected from —H or C1-C5 alkyl. One or more —CH₂— groups are each able to be substituted with —C≡C—, —CH═CH—, —CF₂O—, —O—, —CO—O—, —O—CO— or —O—CO—O—. n, m, p and q are each an integer selected from 0 to 2. Lₐ, L_{b}, L_{c} and L_{d} are each selected from a single bond, —C≡C—, —COO—, —OCO—, —CF₂O—, —OCF₂—, —CH₂O—, —CO—, —O—, —(CH₂)₂—, or —CH═CH—.

According to an exemplary embodiment of the present invention, the light may have a wavelength of about 450 nm to about 495 nm.

According to an exemplary embodiment of the present invention, a ratio γ1/K33 of a rotational viscosity (γ1) to a bending elastic modulus (K33) may be 4 to 8.

According to an exemplary embodiment of the present invention, the liquid crystal compound of Formula 1 may be present in an amount of more than about 0 wt % to about 10 wt %.

According to an exemplary embodiment of the present invention, the liquid crystal compound of Formula 2 may be present in an amount of more than about 0 wt % to about 5 wt %.

According to an exemplary embodiment of the present invention, the liquid crystal compound of Formula 2 may include at least one of liquid crystal compounds represented by Formula 2-1.

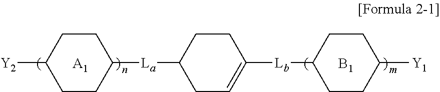

A₁, B₁, n, m, Lₐ, L_{b}, Y₁, and Y₂ may be the same as defined in Formula 2.

According to an exemplary embodiment of the present invention, the liquid crystal composition may have a negative dielectric anisotropy.

According to an exemplary embodiment of the present invention, the liquid crystal layer may be driven in a vertical aligned mode.

### BRIEF DESCRIPTION OF THE DRAWINGS

The above and/or other aspects of the present invention will become apparent and more readily appreciated from the following description of exemplary embodiments thereof, taken in conjunction with the accompanying drawings, in which:

FIG. 1 is a schematic block diagram illustrating a liquid crystal display according to an exemplary embodiment of the present invention;

FIG. 2 is a schematic cross-sectional view illustrating a liquid crystal display according to an exemplary embodiment of the present invention;

FIG. 3 is a plan view illustrating a liquid crystal display according to an exemplary embodiment of the present invention;

FIG. 4 is a cross-sectional view illustrating a liquid crystal display taken along a line I-I′ of FIG. 3 according to an exemplary embodiment of the present invention;

FIG. 5 is a plan view illustrating a liquid crystal display according to an exemplary embodiment of the present invention;

FIG. 6 is a cross-sectional view illustrating a liquid crystal display taken along a line II-II′ of FIG. 5 according to an exemplary embodiment of the present invention; and

FIGS. 7A and 7B are graphs illustrating an illuminance variation in a black state according to an exemplary embodiment of the present invention.

### DETAILED DESCRIPTION OF THE EMBODIMENTS

Exemplary embodiments of the present invention will be described below in more detail with reference to the accompanying drawings. In this regard, the exemplary embodiments may have different forms and should not be construed as being limited to the exemplary embodiments of the present invention described herein.

Like reference numerals may refer to like elements throughout the specification and drawings.

Sizes of elements in the drawings may be exaggerated for clarity of description.

It will be understood that when a component, such as a layer, a film, a region, or a plate, is referred to as being “on” another component, the component can be directly on the other component or intervening components may be present.

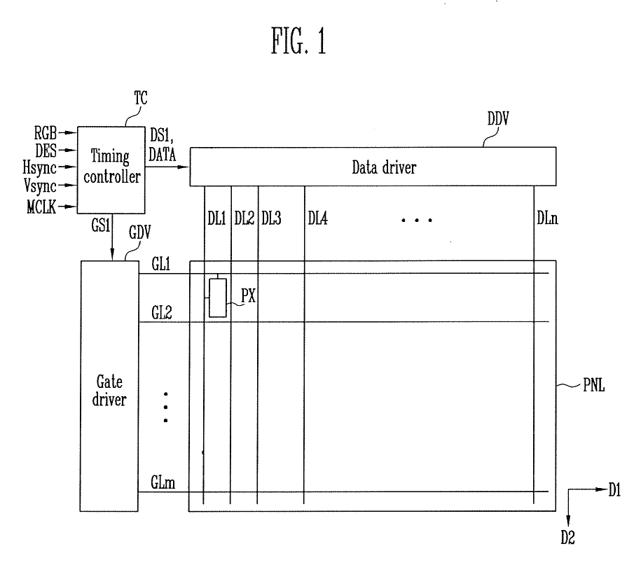

FIG. 1 is a schematic block diagram illustrating a liquid crystal display according to an exemplary embodiment of the present invention.

Referring to FIG. 1, a liquid crystal display may include a display panel PNL, a timing controller TC, a gate driver GDV, and a data driver DDV.

The display panel PNL may be a liquid crystal panel. The display panel PNL may include a first substrate, a second substrate, and a liquid crystal layer. The liquid crystal layer may disposed between the first substrate and the second substrate.

The display panel PNL may include a plurality of gate lines GL1-GLm and a plurality of data lines DL1-DLn. The gate lines GL1-GLm may extend in a first direction D1 (e.g., in a row direction). The data lines DL1-DLn may extend in a second direction D2 (e.g., in a column direction). The second direction D2 may cross the first direction D1. The display panel PNL may include a plurality of pixels PX. The plurality of pixels PX may be arranged in the first direction D1 and the second direction D2.

The timing controller TC may receive image data RGB and a control signal, for example, from an external graphic controller. The control signal may include a vertical synchronization signal Vsync, a horizontal synchronization signal Hsync, a data enable signal DES, and a main clock signal MCLK. The vertical synchronization signal Vsync may be a frame distinguishing signal. The horizontal synchronization signal Hsync may be a row distinguishing signal. The data enable signal DES may be at a relatively high level for a period during which data is output. Thus, the data enable signal DES may indicate an area where data is input.

The timing controller TC may convert the image data RGB, for example, according to specifications of the data driver DDV and outputs a converted image data DATA to the data driver DDV. The timing controller TC may generate a gate control signal GS1 and a data control signal DS1. The data control signal DS1 may be based on the control signal. The timing controller TC may output the gate control signal GS1 to the gate driver GDV. The timing controller TC may also output the data control signal DS1 to the data driver DDV. The gate control signal GS1 may be a signal for driving the gate driver GDV. The data control signal DS1 may be a signal for driving the data driver DDV.

The gate driver GDV may generate a gate signal, for example, based on the gate control signal GS1. The gate driver GDV may output the gate signal to the gate lines GL1-GLm. The gate control signal GS1 may include a scan start signal, at least one clock signal, and an output enable signal. The scan start signal may indicate a start of scanning. The at least one clock signal may control an output period of a gate-on voltage. The output enable signal may confine a duration of the gate-on voltage.

The data driver DDV may generate a gray voltage, for example, according to the image data DATA based on the data control signal DS1. The data driver DDV may output the gray voltage to the data lines DL1-DLn, for example, as a data voltage. The data voltage may include a positive data voltage and a negative data voltage. The positive data voltage may have a positive value with respect to the common voltage. The negative data voltage may have a negative value with respect to the common voltage. The data control signal DS1 may include a horizontal start signal, a load signal, and an inversion signal. The horizontal start signal may indicate a start of transmission of the image data DATA to the data driver DDV. The load signal may apply a data voltage to the data lines DL1 to DLn. The inversion signal may invert a polarity of the data voltage, for example, with respect to the common voltage.

Each of the timing controller TC, the gate driver GDV, and the data driver DDV may be directly mounted on the display panel PNL in a form of at least one integrated circuit chip. Each of the timing controller TC, the gate driver GDV, and the data driver DDV may be mounted on a flexible printed circuit board (FPCB) to be attached to the display panel PNL in a form of a tape carrier package (TCP). Each of the timing controller, the gate driver GDV, and the data driver DDV may be mounted on a separate printed circuit board (PCB). Alternatively, at least one of the gate driver GDV and the data driver DDV may be integrated on the display panel PNL together with the gate lines GL1-GLm, the data lines DL1-DLn, and the transistor. In addition, the timing controller TC, the gate driver GDV, and the data driver DDV may be integrated in a single chip.

A liquid crystal display illustrated in FIG. 1 may be implemented in various forms.

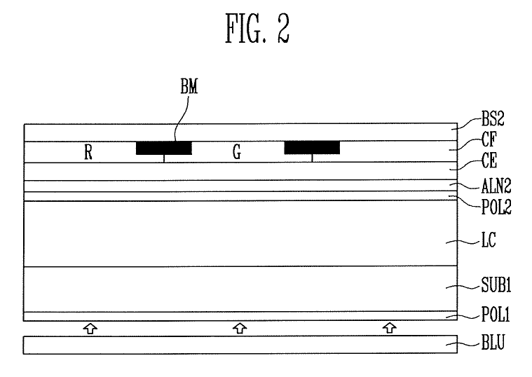

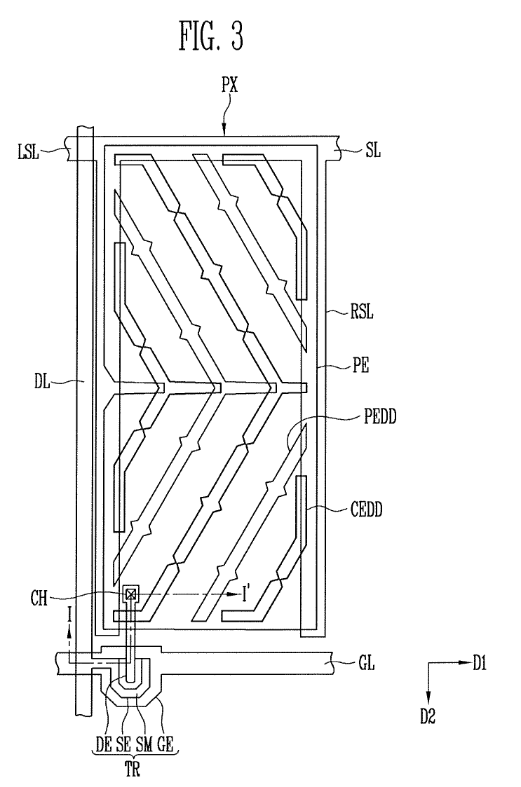

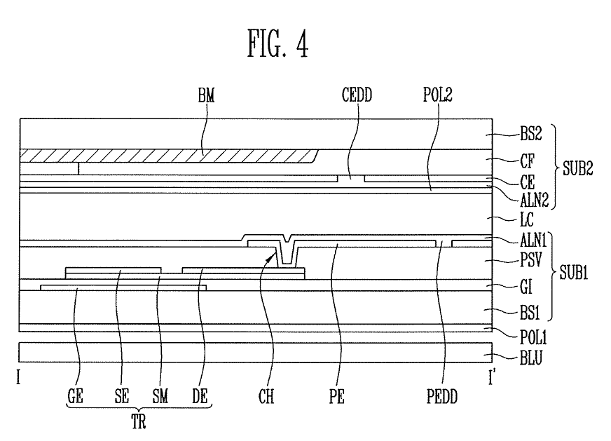

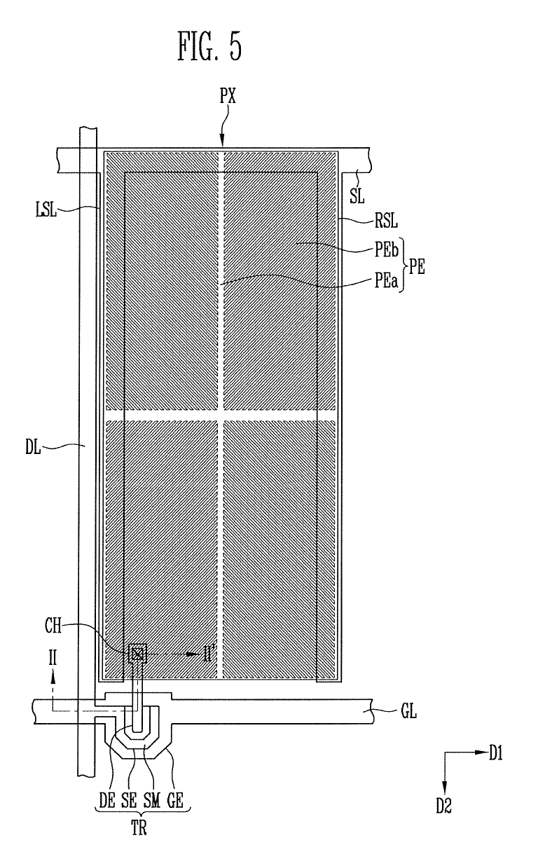

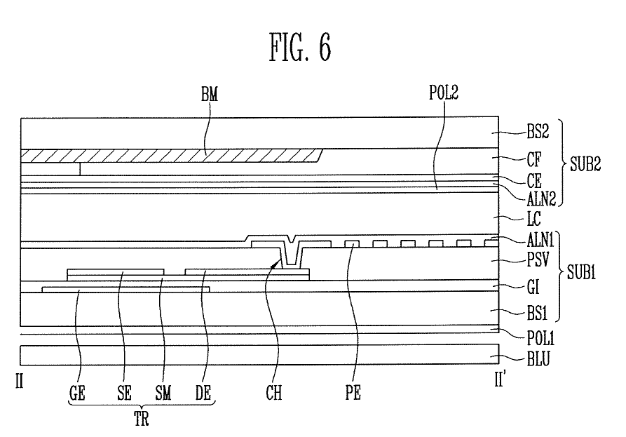

FIG. 2 is a schematic cross-sectional view illustrating a liquid crystal display according to an exemplary embodiment of the present invention. FIG. 3 is a plan view illustrating a liquid crystal display according to an exemplary embodiment of the present invention. FIG. 4 is a cross-sectional view illustrating a liquid crystal display taken along a line I-I′ of FIG. 3 according to an exemplary embodiment of the present invention. FIG. 5 is a plan view illustrating a liquid crystal display according to an exemplary embodiment of the present invention. FIG. 6 is a cross-sectional view illustrating a liquid crystal display taken along a line II-II′ of FIG. 5 according to an exemplary embodiment of the present invention.

Referring to FIGS. 2 to 4, the liquid crystal display may include a first substrate SUB1, a second substrate SUB2, and a liquid crystal layer LC. The second substrate SUB2 may face the first substrate SUB1. The liquid crystal layer LC may be disposed between the first substrate SUB1 and the second substrate SUB2.

The first substrate SUB1 may include a first base substrate BS1, a plurality of gate lines GL, a plurality of data lines DL, a plurality of pixels PX, and a first alignment layer ALN1.

The first substrate SUB1 may include a plurality of pixel areas and a plurality of pixels. The pixel areas may be arranged in a matrix. The pixels may be respectively arranged in the plurality of pixel areas. The pixel PX may be connected to a corresponding one of data lines sequentially arranged and a corresponding one of gate lines adjacent to each other. In the present exemplary embodiment, a gate line to which one pixel is connected may be referred to as a gate line GL. A data line to which the pixel is connected may be referred to as a data line DL.

The gate line GL may be formed on the first base substrate BS1, for example, in a first direction D1. A gate insulating layer GI may be disposed between the data line DL and the gate line GL. The data line DL may extend in the second direction D2. The second direction D2 may cross the first direction D1. The gate insulating layer GI may be disposed on a entire surface of the first base substrate BS1. The gate insulating layer G1 may cover the gate line GL.

Each pixel PX may be connected to a corresponding one of the gate lines GL, and a corresponding one of the data lines DL.

The pixel PX may include a thin film transistor TR, a pixel electrode PE, and a storage electrode. The pixel electrode PE may be connected to the thin film transistor TR.

The thin film transistor TR may include a gate electrode GE, a semiconductor pattern SM, a source electrode SE, and a drain electrode DE.

The gate electrode GE may protrude from the gate line GL. Alternatively, the gate electrode GE may be provided on a portion of the gate line GL.

The gate electrode GE may include a metal. The gate electrode GE may include nickel, chromium, molybdenum, aluminum, titanium, copper, tungsten, or an alloy thereof. The gate electrode GE may have a single-layered structure or a multi-layered structure including metal. For example, the gate electrode GE may have a three-layered structure in which molybdenum, aluminum, and molybdenum are sequentially stacked. Alternatively, the gate electrode GE may have a dual-layered structure in which titanium and copper are sequentially stacked. Alternatively, the gate electrode GE may have a single layered structure including an alloy of titanium and copper.

The gate insulating layer GI may be disposed on the gate electrode GE.

The semiconductor pattern SM may be disposed on the gate insulating layer GI. The semiconductor layer SM may be disposed on the gate electrode GE, and the gate insulating layer GI may be disposed between the semiconductor layer SM and the gate electrode GE. The semiconductor pattern SM may partially overlap the gate electrode GE. The semiconductor pattern SM may be a doped silicon layer or an undoped silicon layer. The silicon layer may be an amorphous silicon layer or a crystalline silicon layer. The semiconductor pattern SM may be an amorphous semiconductor layer or a crystalline oxide semiconductor layer.

The source electrode SE may protrude from the data line DL. The source electrode SE may be formed on an ohmic contact layer. The source electrode SE may partially overlap the gate electrode GE.

The drain electrode DE may be spaced apart from the source electrode SE, and the semiconductor pattern SM may be disposed between the drain electrode DE and the source electrode SE. The drain electrode DE may be formed on the ohmic contact layer. The drain electrode DE may partially overlap the gate electrode GE.

The source electrode SE and the drain electrode DE may include nickel, chromium, molybdenum, aluminum, titanium, copper, tungsten, or an alloy thereof. The source electrode SE and the drain electrode DE may have a single-layered structure or a multi-layered structure including metal. For example, the source electrode SE and the drain electrode DE may have a dual-layered structure in which titanium and copper are sequentially stacked. Alternatively, the source electrode SE and the drain electrode DE may have a single-layered structure including an alloy of titanium and copper.

As the source electrode SE and the drain electrode DE are spaced apart from each other, an upper surface of the semiconductor pattern SM between the source electrode SE and the drain electrode DE may be exposed. The semiconductor pattern SM disposed between the source electrode SE and the drain electrode DE may form a conductive channel between the source electrode SE and the drain electrode DE. The conductive channel between the source electrode SE and the drain electrode DE may be formed depending on whether a voltage is applied to the gate electrode GE.

The storage electrode may include a storage line SL, a first branch electrode LSL, and a second branch electrode RSL. The storage line SL may extend in the first direction D1. The second branch electrode RSL may protrude from the storage line SL. The second branch electrode RSL may extend in the second direction D2.

The pixel electrode PE may be connected to the drain electrode DE, and a passivation layer PSV may be disposed between the pixel electrode PE and the drain electrode DE. The pixel electrode PE may partially overlap the storage line SL, the first branch electrode LSL, and the second branch electrode RSL, for example, to form a storage capacitor.

The passivation layer PSV may cover the source electrode SE, the drain electrode DE, the channel, and the gate insulating layer GI. The passivation layer PSV may include a contact hole CH. The contact hole CH may expose a portion of the drain electrode DE. For example, the passivation layer PSV may include silicon nitride or silicon oxide. According to an exemplary embodiment of the present invention, the passivation layer PSV may have a single-layered structure; however exemplary embodiments of the present inventive concept are not limited thereto. For example, an insulating layer such as the passivation layer PSV may have a multi-layered structure.

The pixel electrode PE may be connected to the drain electrode DE, for example, through the contact hole CH formed in the passivation layer PSV.

The pixel electrode PE may have a first domain divider PEDD. The first domain divider PEDD may divide the pixel PX into a plurality of domains. The first domain divider PEDD may be a cutout or a protrusion formed, for example, by patterning the pixel electrode PE. The cutout may be an aperture or a slit formed, for example, by removing a portion of the pixel electrode PE. The first domain divider PEDD may include a horizontal portion and an oblique portion. The horizontal portion may extend substantially parallel to the first direction D1 or the second direction D2 to bisect a longitudinal direction area of the pixel PX. The oblique portion may be slanted with respect to the first direction D1 or the second direction D2. The oblique portion may be substantially axisymmetric with respect to the horizontal portion.

The pixel electrode PE may include a transparent conductive material. For example, the pixel electrode PE may include a transparent conductive oxide. The transparent conductive oxide may include indium tin oxide (ITO), indium zinc oxide (IZO), indium tin zinc oxide (ITZO), or the like.

The first alignment layer ALN1 may be disposed on the pixel electrode PE, for example, to align liquid crystal molecules of the liquid crystal layer LC.

The second substrate SUB2 may include a second base substrate BS2, a color filter CF, a black matrix BM, a common electrode CE, and a second alignment layer ALN2.

The color filter CF may be disposed corresponding to each pixel PX on the second base substrate BS2. Referring to FIG. 2, the color filter CF may be divided, for example, corresponding to each pixel. The color filter CF may change a wavelength of incident light. For example, the color filter CF may absorb a first light having a first wavelength band, and may emit at least one light having a wavelength band different from the first wavelength band. For example, when light having an ultraviolet wavelength band is absorbed to the color filter CF, the color filter CF may emit light having wavelength band of a blue light, a green light, a red light, respectively, in a visible light wavelength band. Thus, the color filter CF may include quantum dot and/or phosphors. There is no particular limitation on the number of a color filter CF and/or phosphors. Thus, the number of quantum dots and/or phosphors may be determined as needed.

The phosphor included in the color filter CF may be a red phosphor, a blue phosphor, a green phosphor, a yellow phosphor, a white phosphor, or the like. A red phosphor may include at least one selected from Y₂O₂S, La₂O₂S, Ca₂Si₅N₈, Sr₂Si₅N₈, Ba₂Si₅N₈, Kajeun (CaAlSiN₃), La₂ W₃O₁₂, Eu₂ W₃O₁₂, Ca₃MgSi₂O₈, Sr₃MgSi₂O₈, Ba₃MgSi₂O₈, LiEuW₂O₈, or LiSmW₂O₈. A green phosphor may include at least one selected from Ca₂SiO₄, Sr₂SiO₄, Ba₂SiO₄, BAM, α-SiAlON, Ca₃Sc₂Si₃O₁₂, Tb₃Al₅O₁₂, or LiTbW₂O₈. A blue phosphor may include at least one selected from BaMgAl₁₀O₁₇, Mg₅ PO₄₃Cl, Caₛ PO₄₃Cl, Sr₅ PO₄₃Cl, Bas PO₄₃Cl, EuSi₅Al₁₉ON₃₁, or La₁₋ₓCeₓAl (Si_{6-z}Al_{z}) (N_{10-z}O_{z}). A yellow phosphor may include at least one selected from SrGa₂S₄:Eu²⁺, Sr₂Ga₂S₅:Eu²⁺, or YAG:Ce³⁺.

A quantum dot included in the color filter CF may be a II-VI group quantum dot including Cd/Se/ZnS, CdSe/CdS/ZnS, ZnSe/ZnS, or ZnTe/ZnSe. Alternatively, the quantum dot may be a III-V group quantum dot including InP/ZnS, or a quantum dot including CuInS₂/ZnS. The quantum dot may be distributed at a concentration of about 3 g/cm³ to about 6 g/cm³. When a color conversion layer 330 includes the quantum dot, a wavelength band of light converted by the quantum dot may change based on a size of the quantum dot. For example, the quantum dot may be determined as one of a quantum dot emitting green light, a quantum dot emitting red light, or a quantum dot emitting blue light based on the size of the quantum dot.

According to an exemplary embodiment of the present invention, when a light source BLU emits light having a wavelength of about 450 nm to about 495 nm, the color filter CF may have a plurality of quantum dot. For example, the color filter CF may include a first quantum dot emitting light having a green wavelength band and a second quantum dot emitting light having a red wavelength band by receiving light emitted from the light source BLU. The color filter CF may also include a white phosphor emitting light emitted from the light source BLU without varying a wavelength. A yellow phosphor may be additionally disposed on the first quantum dot and the second quantum dot.

The black matrix BM may be disposed between the color filters CF. Alternatively, the black matrix BM may surround the color filter CF. The black matrix BM may block light transmitting the liquid crystal layer LC between adjacent pixels.

According to an exemplary embodiment of the present invention, the color filter CF and the black matrix BM may be disposed on the second substrate SUB2; however, a position of the color filter CF and/or the black matrix BM is not limited thereto. For example, the color filter CF and the black matrix BM may be disposed on the first substrate SUB1.

The common electrode CE may be formed on the color filter CF and the black matrix BM. The common electrode may drive the liquid crystal layer LC, for example, by forming an electric field together with the pixel electrode PE. The common electrode CE may include a transparent conductive material. For example, the common electrode CE may include a conductive metal oxide such as indium tin oxide (ITO), indium zinc oxide (IZO), indium tin zinc oxide (ITZO), or the like.

The common electrode CE may include a second domain divider CEDD. The second domain divider CEDD may divide the pixel PX into a plurality of domains. The second domain divider CEDD may be a cutout or a protrusion formed, for example, by patterning the common electrode CE. The cutout may be an aperture formed, for example, by removing a portion of the common electrode CE. The second domain divider CEDD may include a horizontal portion and/or a vertical portion and an oblique portion. The horizontal portion and/or the vertical portion may extend in parallel in the first direction D1 or the second direction D2 and may bisect a longitudinal direction area of the pixel PX. The oblique portion may be slanted with respect to the first direction D1 or the second direction D2. The oblique portion may be substantially axisymmetric with respect to the horizontal portion.

The horizontal portion of the first domain divider PEDD and the horizontal portion of the second domain divider CEDD may be disposed on substantially the same line. The oblique portion of the first domain divider PEDD and the oblique portion of the second domain divider CEDD may be arranged in parallel in the same direction. The oblique portion of the first domain divider PEDD and the oblique portion of the second domain divider CEDD may be alternately disposed.

The second alignment layer ALN2 may be formed on the common electrode CE. The second alignment layer ALN2 may be disposed on the common electrode CE and may align liquid crystal molecules of the liquid crystal layer LC.

The liquid crystal layer LC may include a liquid crystal composition. The liquid crystal layer LC may be disposed between the first substrate SUB1 and the second substrate SUB2.

The liquid crystal layer LC according to an exemplary embodiment of the present invention may include at least one of liquid crystal compounds represented by Formulae 1 to 2.

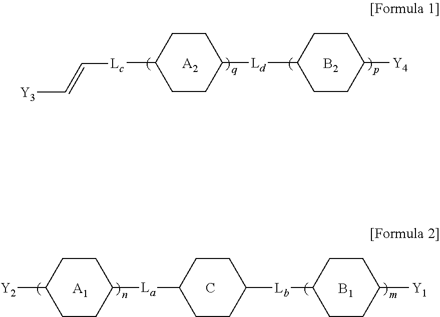

In Formulae 1 and 2, A₁, A₂, B₁ and B₂ may each independently be selected from 1,4-cyclohexylene or 1,4-phenylene.

—H of A₁, A₂, B₁ and B₂ may each independently be substituted with —F, —Cl, —OCF₃, —CF₃, —CHF₂, or —CH₂F.

C may be 1,4-cyclohexenylene having —C═C— bond at a first carbon, a second carbon, or a third carbon.

Y₁, Y₂, Y₃ and Y₄ may each independently be —H or C1-C5 alkyl. One or more —CH₂— groups may each independently substituted with —C≡C—, —CH═CH—, —CF₂O—, —O—, —CO—O—, —O—CO— or —O—CO—O—. Thus, the oxygen atoms might not be directly connected to each other. A hydrogen atom may substituted with halogen.

n, m, p and q may each be an integer electrode from 0 to 2.

Lₐ, L_{b}, L_{c} and L_{d} may each be selected from a single bond, —C═C—, —COO—, —OCO—, —CF₂O—, —OCF₂—, —CH₂O—, —CO—, —O—, —(CH₂)₂—, or —CH═CH—.

According to an exemplary embodiment of the present invention, the liquid crystal compound of Formula 2 may include at least one of liquid crystal compounds represented by Formula 2-1.

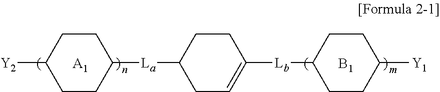

In Formula 2-1, A₁, B₁, n, m, Lₐ, L_{b}, X, Y₁, and Y₂ may be the same as defined in Formula 2.

According to an exemplary embodiment of the present invention, the liquid crystal compound of Formula 1 may be present in the liquid crystal composition in an amount of more than about 0 wt % to about 10 wt %. The liquid crystal compound of Formula 2 may be present in the liquid crystal composition in an amount of more than about 0 wt % to about 5 wt %. Contents of the liquid crystal compound of the Formula 1 and the liquid crystal compound of Formula 2 are numerical values enabling the liquid crystal display according to the present invention to respond at a relatively high speed. A relatively high-speed response may refer to a response speed of the liquid crystal display is relatively fast, for example, the liquid crystal display can be driven at a speed of about 120 Hz or greater. According to an exemplary embodiment of the present invention, when a voltage is applied to the liquid crystal layer, the liquid crystal molecule can move relatively rapidly. Therefore, a light transmittance may be relatively quickly adjusted according to a voltage application. Thus, an output screen may be relatively quickly switched. A speed of about 120 Hz may refer to an output screen that can be switched about 120 times per second.

According to an exemplary embodiment of the present invention, an optical path difference Δnd of liquid crystal layer LC may be about 245 nm to about 310 nm. The optical path difference Δnd may be an optical path difference at a cell gap of about 2.85 μm. Alternatively, the optical path difference Δnd may be an optical path difference when exposed to light having a wavelength of about 450 nm to about 495 nm. The optical path difference of the liquid crystal layer LC may refer to illuminance and luminance in a black state. The liquid crystal layer LC may be in a black state when light is not visible light (e.g., light visible to a user) according to a voltage applied to the liquid crystal layer LC. For example, when the liquid crystal layer LC is driven by a vertical aligned (VA) mode, a liquid crystal compound may be arranged vertically in a black state. As such, light may pass through the liquid crystal layer LC without a phase variation by the liquid crystal compound. Since the liquid crystal layer LC may be disposed between a first polarization layer POL1 and a second polarization layer POL2 which may be perpendicular to each other, the light which passes through the liquid crystal layer LC without a phase variation might not pass through the second polarization layer POL2.

The light incident on a side of the liquid crystal layer LC may be visible to a user, dissimilar to when the light incident on the front surface of the liquid crystal layer LC is not visible to a user in the black state as described above. This side light leakage may increase Illuminance and luminance in the black state. When Illuminance and luminance are increased in the black state, a contrast ratio of an output image may be lowered. Thus, an image quality may be reduced.

A compensation film may be disposed on the liquid crystal layer, for example, to prevent this light leakage. In addition, the optical path difference of the liquid crystal layer LC may be controlled to prevent the side light leakage. In general, as the optical path difference of the liquid crystal layer LC is decreased, illuminance and luminance may be decreased in the black state. However, when the optical path difference of the liquid crystal layer LC is decreased to a predetermined value or less, a reduction of Illuminance and luminance based on a decrease of the optical path difference may be relatively small. In addition, since the optical path difference of the liquid crystal layer LC may affect transmittance of the liquid crystal layer LC, the optical path difference of liquid crystal layer LC cannot be continuously decreased. The optical path difference of about 245 nm to about 310 nm of the liquid crystal layer LC may be in a numerical value range in which an increase of Illuminance and luminance in the black state due to the side light leakage can be minimized without substantially reducing transmittance of the liquid crystal layer LC.

According to an exemplary embodiment of the present invention, a refractive anisotropy Δn of the liquid crystal layer LC may be about 0.075 to about 0.1. The refractive anisotropy Δn may be a value when exposed to light having a wavelength of about 450 nm to about 495 nm. Since the liquid crystal composition of the liquid crystal layer LC may have a refractive anisotropy, a traveling direction of incident light incident on the liquid crystal layer LC may be deflected. The liquid crystal layer LC according to an exemplary embodiment of the present invention may have a refractive anisotropy Δn of a numerical range as described above. Thus, a relatively high quality image may be provided.

According to an exemplary embodiment of the present invention, a ratio γ1/K33 of a rotational viscosity γ1 of the liquid crystal layer and the liquid crystal composition to a bending elastic modulus K33 may be 4 to 8. The liquid crystal display may respond at a relatively high speed, for example, by making the liquid crystal layer LC and the liquid crystal composition have a ratio γ1/K33 of a rotational viscosity γ1 to a bending elastic modulus K33 of a range as described above. For example, the liquid crystal display according to an exemplary embodiment of the present invention may be driven at a speed of about 120 Hz or more. An exemplary embodiment of the present invention may have the ratio (γ1/K33) of the rotational viscosity γ1 to the bending elastic modulus K33 of the range as described above. Thus, a falling time Toff of liquid crystal molecules may be minimized. The liquid crystal molecules may be transformed, for example, when an electric field is applied to the liquid crystal layer LC. The time for the liquid crystal molecules to be transformed by an electric field may be referred to as a rising time Ton. The time for the transformed liquid crystal molecules to relax to an original state may be referred to as a falling time Toff. The falling time and the rotational viscosity satisfy the following Equation. Herein, γ1 may refer to the rotational viscosity of the liquid crystal molecules; d may refer to a distance between the first substrate and the second substrate, (e.g., a cell gap); and K33 may refer to a bending elastic modulus.

$${T}_{off} ∝ \frac{{γ}_{1} {d}^{2}}{{K}_{33}} \qquad [ Equation ]$$

According to an exemplary embodiment of the present invention, as the ratio γ1/K33 of the rotational viscosity γ1 to the bending elastic modulus K33 of the liquid crystal layer LC and the liquid crystal composition is about 4 to about 8, the falling time may be minimized. As such, a response speed of the liquid crystal display may increase.

Further, the liquid crystal layer LC and the liquid crystal composition according to the present invention may have the ratio γ1/K33 of the rotational viscosity γ1 to the bending elastic modulus K33 of the range as described above. Thus, a process reliability in a manufacturing process of the liquid crystal display may be increased. Therefore, the liquid crystal display according to an exemplary embodiment of the present invention may have a relatively a high speed response and a relatively high process reliability. Accordingly, mass production of products may be produced.

A liquid crystal composition according to an exemplary embodiment of the present invention may have a negative dielectric anisotropy. Some of liquid crystal compounds may have a positive dielectric anisotropy. However, the liquid crystal composition, which may include a total sum of liquid crystal compounds, has a negative dielectric anisotropy.

The liquid crystal composition according to an exemplary embodiment of the present invention may be included in a liquid crystal display. The liquid crystal composition according to an exemplary embodiment of the present invention may be included in the liquid crystal display of various modes, e.g., a vertical aligned (VA) mode, a fringe field switching (FFS) mode, an in plane switching (IPS) mode, a plane to light switching (PLS) mode, or the like. Since the liquid crystal composition according to an exemplary embodiment of the present invention may have a relatively high negative dielectric anisotropy and relatively high refractive anisotropy even at a low rotational viscosity, the liquid crystal composition may be applied to a liquid crystal display of a vertical aligned mode using a negative liquid crystal material, e.g., a multi-domain vertical aligned (MVA) mode, a patterned vertical aligned (PVA), a polymer stabilized vertical aligned (PS-VA) mode, or the like. A liquid crystal composition according to an exemplary embodiment of the present invention may have a relatively high refractive anisotropy and relatively low rotational viscosity, and thus in the case where the liquid crystal composition is applied to a liquid crystal display of the vertical aligned mode, the liquid crystal display may provide an image of a relatively high quality.

In the liquid crystal display, when a gate signal is applied to the gate line GL, the thin film transistor may be turned on. Therefore, the data signal applied to the data line DL may be applied to the pixel electrode PE through the thin film transistor. When the thin film transistor is turned on and the data signal is applied to the pixel electrode PE, an electric field may be formed between the pixel electrode PE and the common electrode CE. The liquid crystal molecules may be driven by the electric field generated by a difference between voltages respectively applied to the common electrode CE and the pixel electrode PE. Accordingly, an amount of light passed through the liquid crystal layer LC may be changed to display an image.

The liquid crystal layer LC may be disposed between the first polarization layer POL1 and the second polarization layer POL2. The first polarization layer POL1 and the second polarization layer POL2 may include a linear polarizer and a λ/4 polarizer. Alternatively, the first polarization layer POL1 and the second polarization layer POL2 may include a circular polarizer. When the first polarization layer POL1 includes the linear polarizer and a λ/4 polarizer, a polarization axis of a linear polarizer included in the first polarization layer POL1 may be perpendicular to a polarization axis of a linear polarizer included in the second polarization layer POL2. In addition, a λ/4 polarizer included in the second polarization layer POL2 may have a polarization axis inclined by about +45° with respect to a polarization axis of a linear polarizer included in the second polarization layer POL2. A λ/4 polarizer included in the first polarization layer POL1 may have a polarization axis inclined by about −45° with respect to the polarization axis of the linear polarizer included in the second polarization layer POL2. The polarization axis of the linear polarizer included in the first polarization layer POL1 may be perpendicular to the polarization axis of the linear polarizer included in the second polarization layer POL2. Therefore, when an electric field is not applied to the liquid crystal layer LC, light might not pass through the second polarization layer POL2. Therefore, light emitted from a light source BLU might not be visible to a user according to whether an electric field is applied to the liquid crystal layer LC.

According to an exemplary embodiment of the present invention, a light source may be disposed separate from the second base substrate, and the first base substrate may be disposed between the light source and the second base substrate. The light source BLU may be disposed below the first substrate SUB1 in FIG. 4; however, a position of the light source BLU is not limited thereto.

The light source BLU may emit light passing through the liquid crystal layer so that the liquid crystal display may output an image. The light source BLU may emit light having at least one of red, blue, green, yellow, and white. In addition, the light source BLU may emit not only light in a visible light band but also light in an ultraviolet light band or an infrared light band. Alternatively, a plurality of light sources BLU may be provided. The light sources BLU may emit light of the same color, or may emit light of different color. The light source BLU may include a cold cathode fluorescent lamp (CCFL), an external electrode fluorescent lamp (EEFL), a light emitting diode (LED), a flat fluorescent lamp (FFL), an organic electric light emitting thin film, an inorganic electric light emitting thin film, or the like. In addition, the light source BLU may include compound semiconductor. The compound semiconductor may include two-elements or three-elements selected from 2B, 3B, 4A, 4B, 5B, and 6B groups, such as silicon carbide (SiC), gallium arsenide (GaAs), gallium phosphide (GaP), gallium-arsenic-phosphorous (GaAs₁₋ₓPₓ), gallium-aluminum-arsenic (Ga₁₋ₓAlₓAs), indium phosphide (InP), indium-gallium-phosphorous (In₁₋ₓGaₓP), and the like.

Referring to FIGS. 5 and 6, a liquid crystal display according to an exemplary embodiment of the present invention will be described in more detail below. Different aspects from the exemplary embodiment of the present invention described above will be described in more detail below and repetitive descriptions may be omitted.

Referring to FIGS. 5 and 6, a liquid crystal display according to an exemplary embodiment of the present invention may include a first substrate SUB1, a second substrate SUB2, and a liquid crystal layer LC. The second substrate SUB2 may face the first substrate. The liquid crystal layer LC may be disposed between the first substrate SUB1 and the second substrate SUB2.

The pixel PX may include a thin film transistor TR, a pixel electrode PE, and a storage electrode. The pixel electrode PE may be connected to the thin film transistor TR.

The pixel electrode PE may be provided in a shape different from a shape an exemplary embodiment described above. For example, the pixel electrode PE may include a stem Pea and a plurality of branches PEb. The branches PEb may radially extend from the stem Pea. The branches PEb may be adjacent to each other. A slit may be disposed between adjacent branches PEb. Some of the stem PEa or the branches PEb may be connected to the drain electrode DE, for example, through the contact hole CH.

The stem Pea may be provided in various shapes, for example, in a cross shape. Thus, the pixel PX may be divided into a plurality of domains by the stem PEa, and the branches PEb may respectively correspond to the domains and may respectively extend in different directions for the domains. According to an exemplary embodiment of the present invention, when the pixel may have four domains. The branches PEb may be spaced apart from each other so that one of the branches PEb does not meet an adjacent branch PEb. The branches PEb may extend substantially in parallel in a region divided by the stem PEa. In the branches PEb, a slit between adjacent branches PEb may be spaced apart by a distance of micrometers. The slit may correspond to a domain divider for aligning the liquid crystal molecules of the liquid crystal layer LC at a predetermined angle on a plane parallel to the base substrate.

The second substrate SUB2 may include a second base substrate BS2. A color filter CF, a black matrix BM, a common electrode CE, and a second alignment layer ALN2 may be disposed on the second base substrate BS2. The common electrode CE might not have a separate domain divider. Thus, the common electrode CE may be formed of a single plate.

According to an exemplary embodiment of the present invention, two gate lines and one data line may be connected to one pixel. Alternatively, one gate line and two data lines may be connected to one pixel. According to an exemplary embodiment of the present invention, one pixel may have two sub-pixels to which two different voltages may be applied. A relatively high voltage may be applied to one sub-pixel, and a relatively low voltage may be applied to the other sub-pixel. Elements in the pixel, for example, a gate electrode, a source electrode, a drain electrode, and the like, may be disposed in a structure different from an illustrated structure.

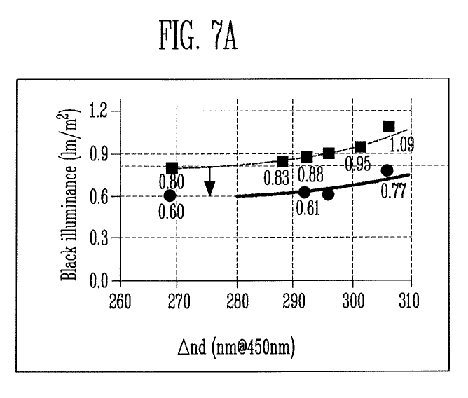

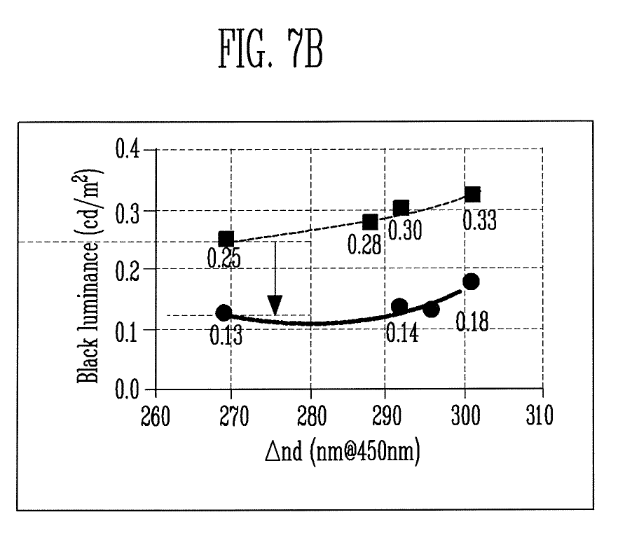

FIGS. 7A and 7B are a graphs illustrating an illuminance variation in a black state based on an optical path difference according to an exemplary embodiment of the present invention.

Referring to FIGS. 7A and 7B, an illuminance variation in a black state based on an optical path difference when different compensation films are used is illustrated. A graph including quadrangle markers may illustrate black illuminance and black luminance when a compensation film having a phase difference of about 250 nm is used. A graph including triangle markers may illustrate illuminance and black luminance when a compensation film having a phase difference of about 270 nm is used.

According to FIGS. 7A and 7B, black illuminance and black luminance may decrease as an optical path difference is decreased regardless of a phase difference of a compensation film. However, when the optical path difference is decreased to a predetermined value or less, a decrease in black Illuminance and black luminance based on a decrease in the optical path difference may be relatively small. Since the optical path difference may also affect transmittance, the optical path difference may be predetermined so as to maximize transmittance while minimizing black illuminance and black luminance. According to an exemplary embodiment of the present invention, a liquid crystal layer and a liquid crystal composition having an optical path difference of about 245 nm to about 310 nm may maximize transmittance while minimizing black illuminance and black luminance.

When a compensation film having a phase difference of about 270 nm is used, black illuminance and black luminance may be further decreased. Since matching between an optical path difference of a liquid crystal layer and a phase difference of a compensation film according to the present invention may be relatively high. The side light leakage described above may be decreased by using the compensation film having a phase difference of about 270 nm. Thus, the black illuminance and the black luminance may be minimized.

While exemplary embodiments of the present invention have been shown and described with reference to certain exemplary embodiments thereof, it will be understood by those skilled in the art that various changes in forms and details may be made therein without departing from the spirit and scope of the present invention as defined by the appended claims and their equivalents.

What is claimed is:

1. A liquid crystal display, comprising:
a first substrate;
a second substrate facing the first substrate;
an electrode unit disposed on at least one of the first substrate and the second substrate; and
a liquid crystal layer disposed between the first substrate and the to second substrate, the liquid crystal layer including a liquid crystal composition,
wherein the liquid crystal composition includes at least one of liquid crystal compounds represented by Formulae 1 to 2: 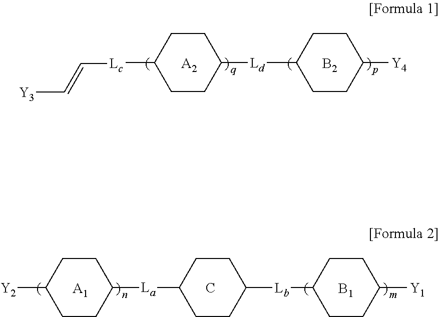
wherein A₁, A₂, B₁ and B₂ are each selected from 1,4-cyclohexylene or 1,4-phenylene,
—H of A₁, A₂, B₁ and B₂ are each able to be substituted with —F, —Cl, —OCF₃, —CF₃, —CHF₂, or —CH₂F,
C is 1,4-cyclohexenylene having —C═C— bond at a first carbon, a second carbon, or a third carbon,
Y₁, Y₂, Y₃ and Y₄ are each selected from —H or C₁-C₅ alkyl, one or more —CH₂— groups are each able to be substituted with —C≡C—, —CH═CH—, —CF₂O—, —O—, —CO—O—, —O—CO— or —O—CO—O—,
n, m, p and q are each an integer selected from 0 to 2,
and Lₐ, L_{b}, L_{c} and L_{d} are each selected from a single bond, —C≡C—, —COO—, —OCO—, —CF₂O—, —OCF₂—, —CH₂O—, —CO—, —O—, —(CH₂)₂—, or —CH═CH—.

2. The liquid crystal display of claim 1, wherein
an optical path difference (Δnd) of the liquid crystal layer is about 245 nm to about 310 nm.

3. The liquid crystal display of claim 1, wherein
a refractive anisotropy (Δn) of the liquid crystal layer is about 0.075 to about 0.1.

4. The liquid crystal display of claim 1, wherein
a ratio γ1/K33 of a rotational viscosity (γ1) to a bending elastic modulus (K33) of the liquid crystal layer is 4 to 8.

5. The liquid crystal display of claim 1, wherein
the liquid crystal compound of Formula 1 is present in an amount of more than about 0 wt % to about 10 wt %.

6. The liquid crystal display of claim 1, wherein
the liquid crystal compound of Formula 2 is present in an amount of more than about 0 wt % to about 5 wt %.

7. The liquid crystal display of claim 1, wherein
the liquid crystal compound of Formula 2 includes at least one of liquid crystal compounds represented by Formula 2-1, 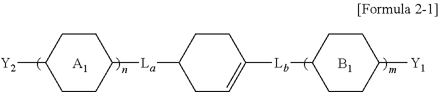
to wherein A₁, B₁, n, m, Lₐ, L_{b}, Y₁, and Y₂ are the same as defined in Formula 2.

8. The liquid crystal display of claim 1, wherein
the liquid crystal composition has a negative dielectric anisotropy.

9. The liquid crystal display of claim 1, wherein
the liquid crystal layer is driven in a vertical aligned mode.

10. The liquid crystal display of claim 1, further comprising:
a light source spaced apart from the second substrate, and the first substrate is disposed between the light source and the second base substrate.

11. The liquid crystal display of claim 11, wherein
the light source emits light having a wavelength of about 450 nm to about 495 nm.

12. The liquid crystal display of claim 1, further comprising:
a color filter disposed on the second substrate,
wherein the color filter has a first quantum dot and a second quantum dot, the second quantum dot is different from the first quantum dot.

13. A liquid crystal composition, comprising:
at least one of liquid crystal compounds represented by Formulae 1 to 2,
wherein the liquid crystal composition has a refractive anisotropy (Δn) of about 0.075 to about 0.1 when exposed to light having a predetermined wavelength: 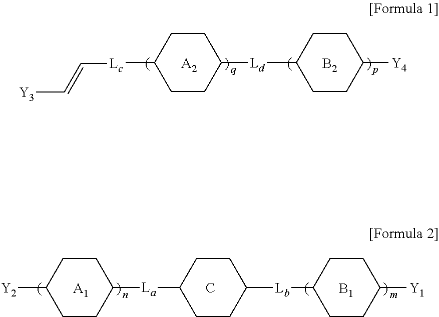
wherein A₁, A₂, B₁ and B₂ are each selected from 1,4-cyclohexylene or 1,4-phenylene,
—H of A₁, A₂, B₁ and B₂ are each able to be substituted with —F, —Cl, —OCF₃, —CF₃, —CHF₂, or —CH₂F,
C is 1,4-cyclohexenylene having —C═C— bond at a first carbon, a second carbon, or a third carbon,
Y₁, Y₂, Y₃ and Y₄ are each selected from —H or C₁-C₅ alkyl, one or more —CH₂— groups are each able to be substituted with —C≡C—, —CH═CH—, —CF₂O—, —O—, —CO—O—, —O—CO— or —O—CO—O—,
n, m, p and q are each an integer selected from 0 to 2,
and Lₐ, L_{b}, L_{c} and L_{d} are each selected from a single bond, —C═C—, —COO—, —OCO—, —CF₂O—, —OCF₂—, —CH₂O—, —CO—, —O—, —(CH₂)₂—, or —CH═CH—.

14. The liquid crystal composition of claim 13, wherein
the light has a wavelength of about 450 nm to about 495 nm.

15. The liquid crystal composition of claim 13, wherein
a ratio γ1/K33 of a rotational viscosity (γ1) to a bending elastic modulus (K33) is 4 to 8.

16. The liquid crystal composition of claim 13, wherein
the liquid crystal compound of Formula 1 is present in an amount of more than about 0 wt % to about 10 wt %.

17. The liquid crystal composition of claim 13, wherein
the liquid crystal compound of Formula 2 is present in an amount of more than about 0 wt % to about 5 wt %.

18. The liquid crystal composition of claim 13, wherein
the liquid crystal compound of Formula 2 includes at least one of liquid crystal compounds represented by Formula 2-1, 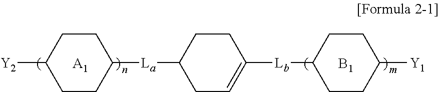
wherein A₁, B₁, n, m, Lₐ, L_{b}, Y₁, and Y₂ are the same as defined in Formula 2.

19. The liquid crystal composition of claim 13, wherein
the liquid crystal composition has a negative dielectric anisotropy.

20. The liquid crystal composition of claim 13, wherein
the liquid crystal layer is driven in a vertical aligned mode.
